(19) United States
(12) Patent Application Publication
(10) Pub. No.: US 2018/0165584 A1
(43) Pub. Date: Jun. 14, 2018

(54) PREDICTING APPLICATION RESPONSE TIME BASED ON METRICS

(71) Applicant: VMWARE, INC., Palo Alto, CA (US)

(72) Inventors: RITESH JHA, Bangalore (IN); DATTATHREYA SATHYAMURTHY, Bangalore (IN); PRATEEK SAHU, Bangalore (IN); NUPUR AGRAWAL, Bangalore (IN); AGAM KAPUR, Bangalore (IN)

(21) Appl. No.: 15/489,764

(22) Filed: Apr. 18, 2017

(30) Foreign Application Priority Data
Dec. 13, 2016 (IN) 201641042482

(51) Int. Cl. G06N 5/04

(52) U.S. Cl. CPC G06N 5/04; G06F 3/0481

(57) ABSTRACT

The present disclosure is related to predicting application response lime based on metrics. An example machine-readable medium may store instructions executable by a processing resource to determine a particular response time and an average response time of an application based on a plurality of relevant performance metrics associated with the application during a first period of time, classify the particular response time into a group based on the average response time, and determine a relationship between the plurality of relevant performance metrics and the particular response time of the application. The example machine-readable medium may further store instructions executable by the processing resource to determine whether a response time of the application is likely to change sufficiently to change the classification to a different group during a second period of time based on the relationship.

### RELATED APPLICATIONS

Benefit is claimed under 35 U.S.C. 119(a)-(d) to Foreign Application Serial No. 201641042482 filed in India entitled “PREDICTING APPLICATION RESPONSE TIME BASED ON METRICS”, on Dec. 13, 2016, by VMware. Inc., which is herein incorporated in its entirety by reference for all purposes.

### BACKGROUND

Virtual computing instances (VCIs), such as virtual machines, virtual workloads, data compute nodes, clusters, and containers, among others, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved aroiuid and scaled to meet changing demands of an enterprise without affecting the use of the enterprise's applications. VCIs can be deployed on a hypervisor provisioned with a pool of computing resources (e.g., processing resources, memory resources, etc.). There are currently a number of different configuration profiles for hypervisors on which VCIs may be deployed.

### BRIEF DESCRIPTION OF THE DRAWINGS

FIG. 1 is a diagram of a host for predicting application response time based on metrics according to the present disclosure.

FIG. 2 is a diagram of a system for predicting application response time based on metrics according to the present disclosure.

FIG. 3 is a diagram of a machine for predicting application response time based on metrics according to (he present disclosure.

FIG. 4 is a flow diagram illustrating a training phase for predicting application response lime based on metrics according to the present disclosure.

FIG. 5 is a flow diagram illustrating a prediction phase for predicting application response time based on metrics according to the present disclosure.

FIG. 6 is a diagram of a system including a plurality of hosts for predicting application response time based on metrics according to (he present disclosure.

FIG. 7 is a diagram of a non-transitory machine readable medium storing instructions for predicting application response time based on metrics according to the present disclosure.

FIG. 8 is a flow diagram illustrating a method for predicting application response time based on metrics according lo the present disclosure.

### DETAILED DESCRIPTION

The term “virtual computing instance” (VCI) covers a range of computing functionality. VCIs may include non-virtualized physical hosts, virtual machines (VMs), and/or containers. Containers can run on a host operating system without a hypervisor or separate operating system, such as a container that runs within Linux. A container can be provided by a virtual machine that includes a container virtualization layer (e.g., Docker). A VM refers generally to an isolated end user space instance, which can be executed within a virtualized environment. Other technologies aside from hardware visualization can provide isolated end user space instances may also be referred to as VCIs. The term “VCI” covers these examples and combinations of different types of VCIs, among others.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VM segregation that may be offered in hypervisor-virtualized environments that virtualize system hardware, and thus can be viewed as a form of virtualization that isolates different groups of applications that operate in different containers. Such containers may be more lightweight than VMs.

Multiple VCIs can be configured to be in communication with each other in a software defined data center. In such a system, information can be propagated from an end user to at least one of the VCIs in the system, between VCIs in the system, and/or between at least one of the VCIs in the system and a non-virtualized physical host.

Software defined data centers are dynamic in nature. For example, VCIs and/or various application services, may be created, used, moved, or destroyed within the software defined data center. When VCIs are created (e.g., when a container is initialized), various processes and/or services start running and consuming resources. As used herein, “resources” are physical or virtual components that have a finite availability within a computer or software defined data center. For example, resources include processing resources, memory resources, electrical power, and/or input/output resources, etc.

A challenge posed to software defined data center administrators is keeping application running while maintaining an optimal or near optimal performance level. For example, in a software defined data center where business critical applications are running, it may be beneficial to ensure that the business critical applications are running at all times and that the business critical applications are running at an optimal (or at least a near optimal) performance level. If such applications slow down (or crash), a customer's experience may be directly impacted. In some examples, an application slowdown may be a result of application program interface (API) calls slowing down. An example of an API call may be a business critical transaction. As used herein, an “application” is a set of instructions that, when executed (e.g., when executed by a processing resource) perform one or more coordinated functions, tasks, and/or activities that may provide a benefit to a user. As used herein, a “business critical transaction” is a transaction whose failure may result in the failure of some goal-directed activity. For example, a failure that can influence an entire company or organization by stopping (or partially stopping) activity that is critical to the business or organization.

Various factors may affect the performance level of an application. For example, an increase in a server load, a lack of sufficient infrastructural resources, and/or an occurrence of exceptions or errors at a host may affect the performance level of an application. Another factor that may affect the performance level of an application is that some applications may run well in isolation, but may experience reduced performance (e.g., application slowdown) when run simultaneously with some other applications. There may be hundreds of such factors affecting the performance of one or more applications in real time, which may make it extremely difficult to understand patterns that may be indicative of application slowdown. As a result, predicting application slowdown in order to avoid potential application slowdowns may be an extremely difficult task.

Some factors that may affect application performance may be related to the application itself and/or infrastructure associated with the software defined data center. The effects of such factors may be complex and inter-related. For example, rather than applications having a direct effect on each other or on application performance, the effects may be more complex and inter-related. As a result, identifying scenarios that may lead to application slowdown in a software defined data center may be a nearly impossible task for an administrator, and the difficulty of identifying such scenarios may become increasingly difficult as the number of components in a software defined data center increases.

Although some approaches may allow for operation management and/or application monitoring, these approaches may suffer from a number of shortcomings. For example, some administrator management tools may allow for monitoring and/or troubleshooting infrastructure level issues for an application while some application monitoring tools may allow for monitoring and/or troubleshooting application level statistics. However, some of these approaches are reactive. That is, such tools may not allow for proactive prediction of application slowdowns before they happen. In contrast, embodiments of the present disclosure may allow for prediction of application slowdowns before they occur, which may allow for issues related to application slowdown to be proactively corrected.

In some embodiments, prediction of application slowdown may include determining a relationship between the various factors described above to predict application slowdown. For example, application performance behavior may be determined, which may allow for prediction of application slowdown. In some embodiments, machine learning may be employed to determine the complex relationships between the various factors described above in order to predict future application performance and/or future application slowdown.

In some embodiments, application level metrics and/or infrastructure level metrics may be used to facilitate prediction of application slowdown before the slowdown occurs. This may allow for an opportunity to troubleshoot issues that may lead to the slowdown before the slowdown occurs and/or may provide insight on factors that are related and may lead lo such slowdowns. This insight may allow for administrators to manage resources in a manner consistent with avoiding future application slowdown. In some embodiments, prediction of application slowdown may facilitate autonomous self-healing of software defined data centers.

In some embodiments, a prediction model may be generated for at least one application (e.g., a transaction, API call, etc.). The prediction model may be based on various application level and infrastructure level metrics, various response times associated with applications, and may learn over time based on such metrics.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

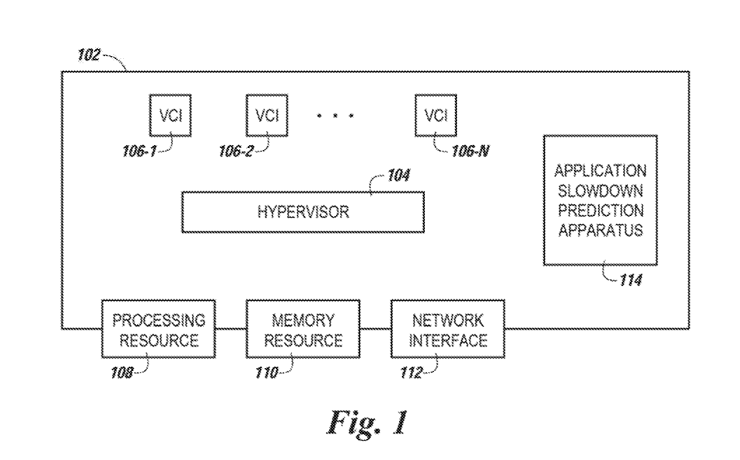

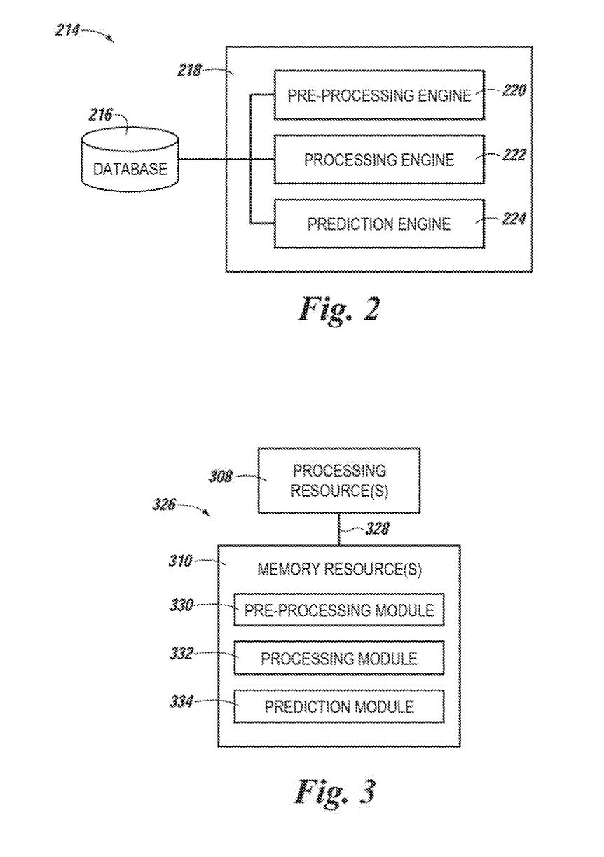

The figures herein follow a numbering convention in which the first digit or digits correspond to the drawing figure number and the remaining digits identify an element or component in the drawing. Similar elements or components between different figures may be identified by the use of similar digits. For example, 114 may reference element “14” in FIG. 1, and a similar element may be referenced as 214 in FIG. 2. A group or plurality of similar elements or components may generally be referred to herein with a single element number. For example a plurality of reference elements 106-1, 106-2, . . . , 106-N may be referred to generally as 106. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

Embodiments of the present disclosure are directed to predicting application response time based on metrics, for example, in the context of a software defined data center (e.g., a distributed computing environment) including one or more VCIs and/or hosts. In some embodiments, an example machine-readable medium may store instructions executable by a processing resource to determine a particular response time and an average response time of an application based on a plurality of relevant performance metrics associated with the application during a first period of time, classify the particular response time into a group based on the average response time, and determine a relationship between the plurality of relevant performance metrics and the particular response time of the application. The example machine-readable medium may further store instructions executable by die processing resource to determine whether a response time of the application is likely to change sufficiently to change the classification to a different group during a second period of time based on the relationship.

FIG. 1 is a diagram of a host 102 for predicting application response time based on metrics according to the present disclosure. The system can include a host 102 with processing resources 108 (e.g., a number of processors), memory resources 110 (e.g., main memory devices and/or storage memory devices), and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of VCIs 106-1, 106-2, . . . , 106-N (referred to generally herein as “VCIs 106”). The VCIs can be provisioned with processing resources 10S and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and are not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. In some embodiments, a VCI among the number of VCIs can be a master VCI. For example. VCI 106-1 can be a master VCI, and VCIs 106-2, . . . , 106-N can be slave VCIs. The host 102 can be connected to (e.g., in communication with) an application slowdown prediction apparatus 114.

In some embodiments, the application slowdown prediction apparatus 114 can be configured to predict future slowdown of applications associated with a software defined data center, as described in more detail herein. In some embodiments, the application slowdown prediction apparatus 114 can be deployed on (e.g., may be running on) the host 102, and/or one or more of the VCIs 106. In some embodiments, the application slowdown prediction apparatus 114 can be deployed on the host 102 or a VCI (e.g., VCI 106-1), which may be the only host 102 or VCI (e.g., VCI 106-1) that is running or is provisioned with a pool of computing resources. However, in some embodiments, the application slowdown prediction apparatus 114 may be deployed across multiple hosts and/or VCIs, for example hosts and/or VCIs not specifically illustrated in FIG. 1.

In some embodiments, die application slowdown prediction apparatus 114 can include a combination of software and hardware, or the application slowdown prediction apparatus 114 can include software and can be provisioned by processing resource 108. An example of application slowdown prediction apparatus 114 is illustrated and described in more detail with respect to FIG. 2.

FIG. 2 is a diagram of an apparatus for packet generation and injection according to the present disclosure. The apparatus 214 can include a database 216, a subsystem 218, and/or a number of engines, for example pre-processing engine 220, processing engine 222, and/or prediction engine 224. The engines 220, 222, 224 can be in communication with the database 216 via a communication link. The apparatus 214 can include additional or fewer engines than illustrated to perform the various functions described herein. The apparatus 214 can represent program instructions and or hardware of a machine (e.g., machine 326 as referenced in FIG. 3, tic). As used herein, an “engine” can include program instructions and/or hardware, but at least includes hardware. Hardware is a physical component of a machine that enables it lo perform a function. Examples of hardware can include a processing resource, a memory resource, a logic gate, etc.

The number of engines (e.g., 220, 222, 224) can include a combination of hardware and program instructions that are configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can lie considered as both program instructions and hardware.

In some embodiments, the pre-processing engine 220 can include a combination of hardware and program instructions that can be configured to determine a particular response time and an average response time of an application based on a plurality of relevant performance metrics associated with the application during a first period of time. For example, the pre-processing engine 220 can include a combination of hardware and program instructions that can be configured to determine an average response lime for an application over a particular period of time. In addition, the pre-processing engine 220 can include a combination of hardware and program instructions that can be configured to determine a particular response time for an application. As used herein, a particular response time is a response time for an application at a current point in time. For example, the particular response time for an application is an observed or recorded instantaneous response time for the application.

The pre-processing engine 220 can include a combination of hardware and program instructions that can be configured to classify the particular response time into a group based on the average response time. For example, the pre-processing engine 220 can include a combination of hardware and program instructions that can be configured to classify the particular response time into various groups based on its relation to the average response lime for the application, as described in more detail in connection with Table 1, herein.

The processing engine 222 can be configured to determine a relationship between the plurality of relevant performance metrics and the particular response time of the application. In some embodiments, determining the relationship between the plurality of relevant performance metrics and the particular response lime of the application can include performing machine learning on the plurality of relevant performance metrics and the particular response time of the application in order to determine the relationship between the plurality of relevant performance metrics and the particular response lime of the application.

The prediction engine 224 can be configured to determine whether a response time of the application is likely to change sufficiently to change the classification to a different group during a second period of time based on the relationship. In some embodiments, the response lime of the application being likely to change sufficiently to change the classification to a different group may include determining that the application is going to experience application slowdown at some point in the future, for example, it may be determined that an application that is currently associated with a group that indicates that the application is running at a normal response time is going to, at some point in the future, become associated with a group that indicates that the application is not running at a normal response time (e.g., the application is likely to, at some point in the future, experience application slowdown and become associated with a group that indicates a non-normal response time for the application).

FIG. 3 is a diagram of a machine for packet generation and injection according to the present disclosure. The machine 326 can utilize software, hardware, firmware, and/or logic to perform a number of functions. The machine 326 can be a combination of hardware and program instructions configured to perform a number of functions (e.g., actions). The hardware, for example, can include a number of processing resource's) 308 and a number of memory resource(s) 310, such as a machine-readable medium (MRM) or other memory resource(s) 310. The memory resource(s) 310 can be internal and/or external to the machine 326 (e.g., the machine 326 can include internal memory resources and have access to external memory resources). In some embodiments, the machine 326 can be a VCI, for example, the machine 326 can be a server. The program instructions (e.g., machine-readable instructions (MRI)) can include instructions stored on the MRM to implement a particular function (e.g., an action such as predicting application response time based on metrics). The set of MRI can be executable by one or more of the processing resource(s) 30S. The memory resource(s) 310 can be coupled to the machine 326 in a wired and/or wireless manner. For example, the memory resource(s) 310 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resource(s) 310 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as oilier types of machine-readable media.

The processing resource(s) 308 can be coupled to the memory resource(s) 310 via a communication path 328. The communication path 328 can be local or remote to the machine 326. Examples of a local communication path 328 can include an electronic bus internal to a machine, where the memory resource(s) 310 are in communication with the processing resource(s) 308 via The electronic bus. Examples of such electronic buses can include Industry Standard Architecture (ISA). Peripheral Component Interconnect (PCI), Advanced Technology Attachment (ATA), Small Computer System Interface (SCSI), Universal Serial Bus (USB), among oilier types of electronic buses and variants thereof. The communication path 328 can be such that the memory resource(s) 310 are remote from the processing resource(s) 308, such as in a network connection between the memory resources 310 and the processing resources 308. That is, in some embodiments, the communication path 328 can be a network connection. Examples of such a network connection can include a local area network (LAN), wide area network (WAN), personal area network (PAN), and the Internet, among others.

As shown in FIG. 3, the MRI stored in the memory resource(s) 310 can be segmented into a number of modules 330, 332, and 334 that when executed by the processing resource(s) 308, can perform a number of functions. As used herein a module includes a set of instructions included to perform a particular task or action. The number of modules 330, 332, 334 can be sub-modules of other modules. For example, the processing module 332 can be a sub-module of the pre-processing module 330 and/or can be contained within a single module. Furthermore, the number of modules 330, 332, 334 can comprise individual modules separate and distinct from one another. Examples are not limited to the specific modules 330, 332, 334 illustrated in FIG. 3.

Each of the number of modules 330, 332, 334 can include program instructions and/or a combination of hardware and program instructions that, when executed by processing resource(s) 308, can function as a corresponding engine as described with respect to FIG. 2. For example, the pre-processing module 330 can include program instructions and/or a combination of hardware and program instructions that, when executed by processing resource(s) 308, can function as the pre-processing engine 220, the processing module 332 can include program instructions and/or a combination of hardware and program instructions that, when executed by processing resource(s) 308, can function as the processing engine 222, and/or the prediction module 334 can include program instructions and/or a combination of hardware and program instructions that, when executed by processing resource(s) 308, can function as die prediction engine 224.

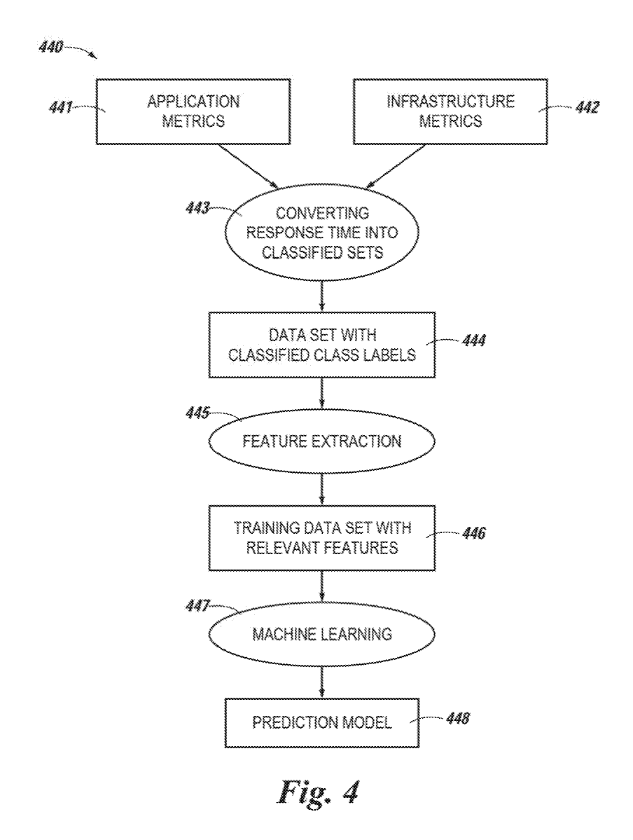

FIG. 4 is a flow diagram 440 illustrating a training phase for predicting application response time based on metrics according to the present disclosure. At block 441 application metrics may be collected, and at block 442, infrastructure metrics may be collected. For example, application metrics 441 and infrastructure metrics 442 may be collected to construct an input dataset. In some embodiments, the application metrics 441 may be collected via an application monitoring tool, while the infrastructure metrics 442 may be collected via an infrastructure management tool. The application metrics 441 and the infrastructure metrics 442 may be pre-processed, for example, to construct a training dataset. In some embodiments, pre-processing the application metrics 441 and the infrastructure metrics 442 may include various steps and/or sub-steps.

In some embodiments, a step and/or sub-step in pre-processing the application metrics 441 and the infrastructure metrics 442 may include classifying response time into groups (e.g., classified sets, categories, etc.), as shown at block 443. The groups may represent response times for various applications (e.g., transactions) in terms of groups, as shown in Table 1, where R_{ι} is the response time, μ is the average response time, and σ is the standard deviation.

TABLE 1

| Response Time | Categorical label |
|---|---|
| R_{τ} ≤ μ | Normal |
| (μ + σ) ≥ R_{τ} > μ | Slow |
| R_{τ} > (μ + σ) | Very Slow |
| R_{τ} = −1 | Stall |

As shown in Table 1, the response lime of the application (e.g., the response rime of an API call) and an average response time of the application may be used to categorize the response lime into four categories; Normal, Slow, Very Slow, or Stall. In the Stall case where R_{γ}=−1, the application may have crashed or otherwise become unresponsive. In some embodiments, the Normal category may indicate that the application has a response time that may be characterized as a normal response lime for the application. Whether or not the response time is Normal may be determined based on the average amount of time that is associated with the application. The Slow, Very Slow, and Stall categories may indicate that the application has a response time that may be characterized as non-normal. That the response time is categorized as non-normal may be based on a determination that the application takes a longer period of time than an average response time for the application.

At blocks 441 and 442, when application metrics and infrastructure metrics are collected, some collected metrics may not affect the response time of the application. If all the collected metrics are considered (e.g., considered as features for a feature set), the complexity of a machine teaming model, as well a training lime, may increase. In order to reduce the number of metrics for use in predicting application slowdown, collected metrics that do not affect the response time of the application may be removed. For example, at block 445, feature extraction may be performed to extract a set of relevant metrics from the collected application metrics 441 and infrastructure metrics 442. In sonic embodiments, feature extraction 445 may be performed using Minimum-Redundancy-Maximum-Relevance (mRMR) techniques. However, embodiments are not so limited, and feature extraction 445 may be performed using other techniques that achieve similar results.

In some embodiments, at 445, feature extraction may include receiving a complete data set containing all metrics collected as features, and may output the relevant metrics as a set of features that are relevant for predicting the response time. These output relevant metrics may be used for training a prediction model, as discussed in more detail in connection with blocks 446,447, and 448, herein. In some embodiments, the feature extraction at 445 may reduce the complexity of a predictive model (e.g., prediction model 44S) and may also improve the performance of the classification (e.g., block 443) by reducing over fitting.

Training the data set with relevant features may be performed at block 446. For example, the data set acquired from the preceding blocks of FIG. 4. The data set to be trained may include the relevant metrics with the response times categorized into multiple groups or classes, as described above. This data set may be used to train, at block 446, a multiclass machine learning 447 mechanism for learning a relationship between the various application metrics 441, infrastructure metrics 442, and the response time of various applications. In some embodiments, the multiclass machine learning mechanism may be a support vector machine (SVM).

At block 448, a prediction model may be constructed. The prediction model may include the relationship between the relevant application metrics and relevant infrastructure metrics, as determined by the machine learning 447 mechanism, and the response time of an application associated with the relevant application metrics and relevant infrastructure metrics that were extracted at block 445 via feature extraction. In some embodiments, the prediction model 448 may be used to predict future application slowdown. For example, the prediction model 448 may be used to predict a likelihood that an application will experience application slowdown within a configurable time interval.

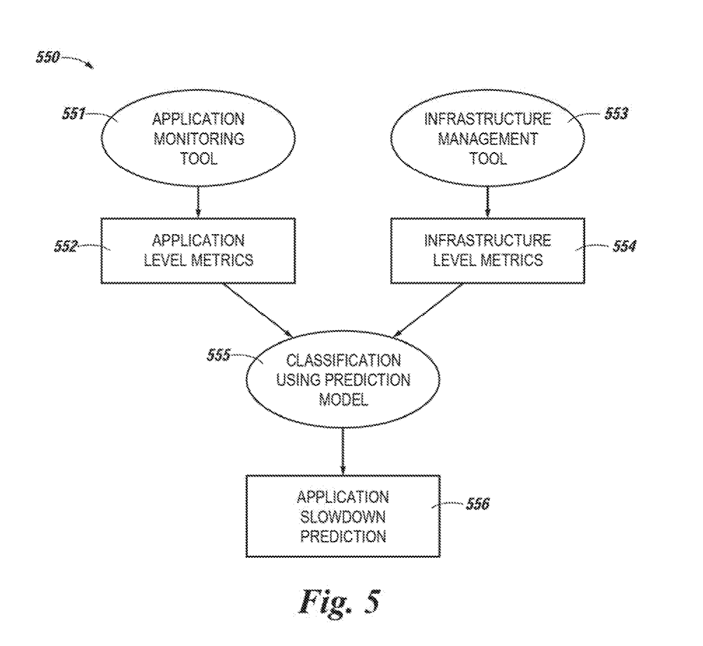

FIG. 5 is a flow diagram 550 illustrating predicting application slowdown for predicting application response time based on metrics according to the present disclosure. At block 551, an application monitoring tool may generate application level metrics 552. At block 553, an infrastructure management tool may generate infrastructure level metrics 554. At block 555, classification using the prediction model (e.g., prediction model 448 in FIG. 4) may be performed. In some embodiments, after the prediction model is generated, at block 556, application slowdown prediction may be performed. For example, the prediction model (e.g., prediction model 448 in FIG. 4) may be used to predict a likelihood that an application and/or transaction may experience application slowdown in a particular time interval.

In some embodiments, the time interval may be configurable and/or may be based on a user input. For example, if the time interval is 10 minutes, a prediction model that can predict application slowdown for the next 10 minutes may be generated. In some embodiments, if the time interval is 10 minutes, a group or class label in the training data may be logged after 10 minutes of logging the metrics to be used in the training data.

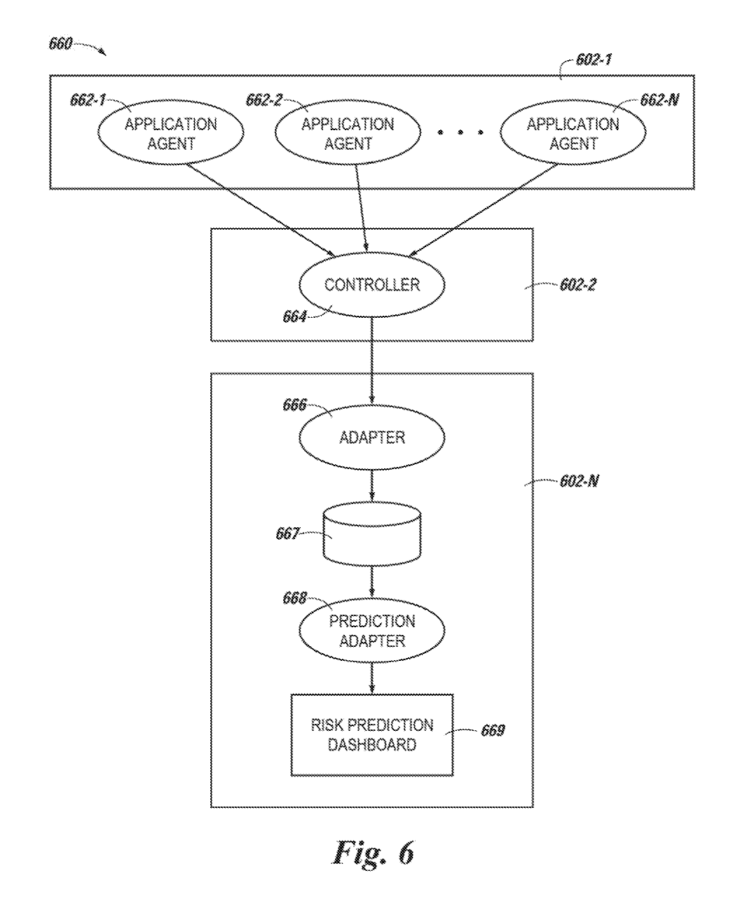

FIG. 6 is a diagram of a system 660 including a plurality of hosts 602-1, . . . , 602-N for predicting application response time based on metrics according to the present disclosure. As illustrated in figure 6, the system 660 includes a first host 602-1, second host 602-2, and third host 602-N. Each host among the plurality of hosts 602 may be provisioned with a respective processing resource and a respective memory resource. In some embodiments, each of the hosts 602 may include various components, as discussed in more detail below.

A plurality of application agents 662-1, . . . , 662-N (refined to generally herein as application agents 662) may be associated with the first host 601-2. The plurality of application agents 662 may monitor performance of applications, for example, applications running in a software defined data center. In some embodiments, the application agents 662 may collect application level metrics for applications running in a software defined data center.

The system 660 may include a second host 602-2, which may include a controller 664. In some embodiments, the controller 664 may be an application dynamic controller, such as an AppDynamics controller. The controller 664 may include a monitoring tool, and may be used to determine information regarding application level metrics and/or infrastructure level metrics generated and/or collected by the plurality of application agents 662.

The system 660 may include a third host 602-N, which may include an adapter 666, storage location 667, prediction adapter 668, and/or risk prediction dashboard 669. In some embodiments, the adapter 666 may be associated with an operations management suite running on a software defined data center. Hie adapter 666 may be configured to collect application monitoring data from the controller 664. In some embodiments, the adapter 666 may collect application monitoring data from the controller 664 through REST APIs, and may push the application monitoring data to a storage location 667. The storage location 667 may be a database, for example.

In some embodiments, the third host 602-N may include a predication adapter 668, which may receive the application level metrics and/or infrastructure level metrics and may use the metrics to determine how an application behaves based on the metrics and the response time of the application. The application level metrics and/or infrastructure level metrics received by the prediction adapter 668 may be relevant application level metrics and/or relevant infrastructure level metrics. In some embodiments, the prediction adapter 668 may perform machine learning to determine how the applications behave based on the metrics and response time of the application. The third host (e.g., host 602-N) may further include a risk prediction dashboard 669. which may show (e.g., display) application slowdown risk for various applications based on a prediction model.

In some embodiments, the first host 602-1 may be configured to generate a plurality of application level performance metrics associated with respective applications among a plurality of applications. The respective applications may include application program interface (API) calls. The first host 602-1 may include a plurality of application agents configured to generate the plurality of application level performance metrics.

In some embodiments, the controller 664 included on the second host 602-2 may be configured to receive the plurality of application level performance metrics and determine relevant application level performance metrics from the plurality of application level performance metrics. The controller 664 may be further configured to generate a plurality of relevant infrastructure level performance metrics associated with the respective applications among the plurality of applications.

In some embodiments, the third host 602-N may be configured to receive the plurality of relevant infrastructure performance metrics and the plurality of relevant application level performance metrics. For example, the adapter 666 associated with the third host 602-N may be configured to receive the plurality of relevant infrastructure performance metrics and the plurality of relevant application level performance metrics.

The third host 602-N may be configured to determine a relationship between the plurality of relevant application level metrics, the plurality of relevant infrastructure level metrics, and a particular response time associated with each respective application among the plurality of applications and determine, based on the relationship, whether the response time associated with a particular application among the plurality of applications is likely to change within a configurable time interval. For example, the prediction adapter 668 may be configured to determine a relationship between the plurality of relevant application level metrics, the plurality of relevant infrastructure level metrics, and a particular response time associated with each respective application among the plurality of applications and determine, based on the relationship, whether the response time associated with a particular application among the plurality of applications is likely to change within a configurable time interval,

One or more components associated with the third host 602-N may be further configured to classify the respective applications into respective categories among a plurality of categories, wherein each category among the plurality of categories is based on the particular response time data associated with the respective application and an average response time associated with the respective application. In some embodiments, at least one category among the plurality of categories indicates that the respective application is operating at a normal response time, and wherein at least one category among the plurality of categories indicates that the respective application is operating at a non-normal response time. For example, the non-normal response time may indicate that the respective application is in a stall slate.

In some embodiments, the third host 602-N may include a risk prediction dashboard to display a level of risk indicating how likely it is that the response time associated with the particular application among the plurality of applications will change within the configurable time interval.

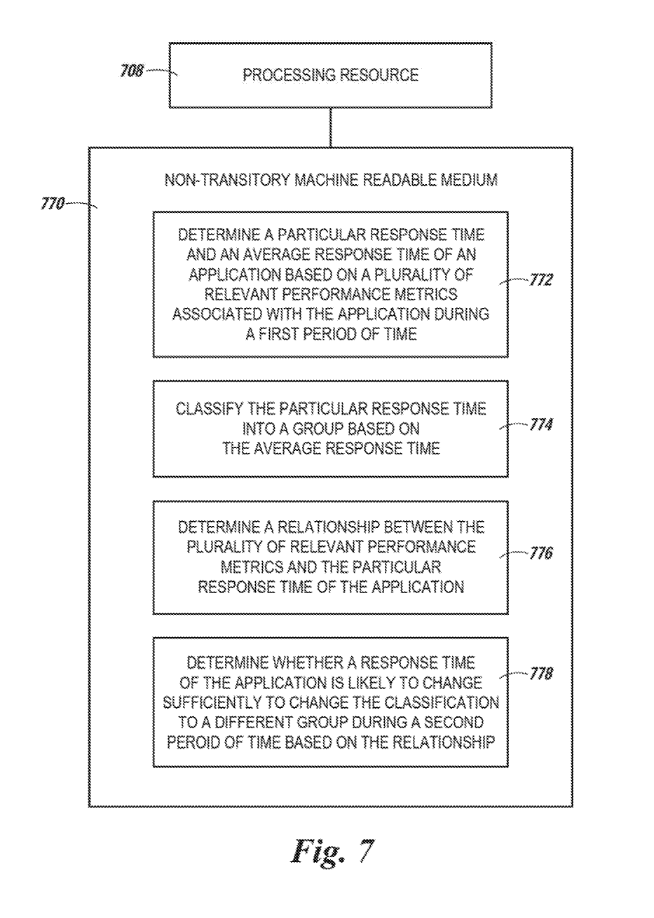

FIG. 7 is a diagram of a non-transitory machine readable medium 770 storing instructions for predicting application response time based on metrics according to the present disclosure. A processing resource 708 may execute instructions stored on the non-transitory machine readable medium 770. The non-transitory machine readable medium 770 may be any type of volatile or non-volatile memory or storage, such as random access memory (RAM), flash memory, read-only memory (ROM), storage volumes, a hard disk, or a combination thereof.

In some embodiments, the non-transitory machine readable medium 770 may store instructions 772 executable by the processing resource 708 to determine a particular response time and an average response time of an application based on a plurality of relevant performance metrics associated with the application during a first period of time. The relevant performance metrics may include an application level performance metric and an infrastructure level performance metric.

The non-transitory machine readable medium 770 may store instructions 774 executable by the processing resource 708 to classify the particular response time into a group based on the average response time. In some embodiments, each respective group may represent a discrete time interval associated with a particular range of time associated with the particular response time and the average response lime.

The non-transitory machine readable medium 770 may store instructions 776 executable by the processing resource 708 to determine a relationship between the plurality of relevant performance metrics and the particular response time of the application.

The non-transitory machine readable medium 770 may store instructions 778 executable by the processing resource 70S to determine whether a response time of the application is likely to change sufficiently to change the classification to a different group during a second period of time based on the relationship.

In some embodiments, the instructions to determine whether the response time of the application is likely to change sufficiently to change the classification to the different group during the second period of time may include instructions to determine whether the response time of the application is likely to change sufficiently to change the classification to the different group during the second period of lime based on updated relevant performance metrics, in some embodiments, the instructions to determine whether the response time of the application is likely to change may include instructions to determine whether the response time of the application is likely to increase during the second period of time.

The non-transitory machine readable medium 770 may store instructions executable by the processing resource 708 to generate an alert indicating that the response lime of the application is likely to change. In some embodiments, the instructions may be further executable by the processing resource 708 to send the alert to a user. For example, the instructions may be further executable by the processing resource 708 to display, via a graphical user interface, a likelihood that the particular response time of the application is likely to change.

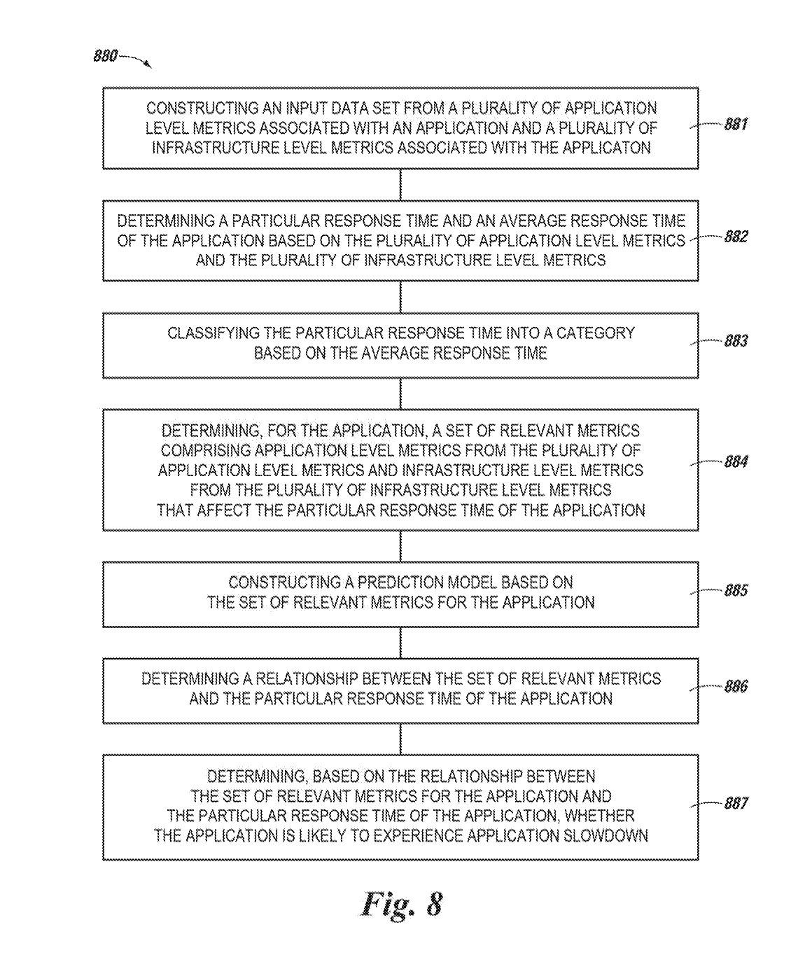

FIG. 8 is a flow diagram illustrating a method 880 for predicting application response lime based on metrics according to the present disclosure. At block 881, the method 880 may include constructing an input data set from a plurality of application level metrics associated with an application and a plurality of infrastructure level metrics associated with the application.

At block 882, the method 880 may include determining a particular response time and an average response time of the application based on the plurality of application level metrics and the plurality of infrastructure level metrics. At block 883, the method 880 may include classifying the particular response time into a category based on the average response time, as described in more detail in connection with Table 1, herein.

At block 884, the method 880 may include determining, for the application, a set of relevant metrics comprising application level metrics from the plurality of application level metrics and infrastructure metrics from the plurality of infrastructure metrics that affect the particular response time of the application.

At block 885, the method 880 may include constructing a prediction model based on the set of relevant metrics for the application. At block 886, the method may include determining a relationship between the set of relevant metrics and the particular response time of the application. At block 887, the method 880 may include determining, based on the relationship between the set of relevant metrics for the application and the particular response time of the application, whether the application is likely to experience application slowdown,

In some embodiments, the method 880 may include generating, in response to determining whether the application is likely to experience application slowdown, an alert indicating that the application is likely to experience application slowdown. The method 880 may further include determining whether the application is likely to experience application slowdown within a configurable time interval.

In some embodiments, the method 880 may include prior to determining whether the application is likely to experience application slowdown, determining the relationship between the set of relevant metrics for the application and the particular response time of the application using a machine learning technique. For example, the method 880 may include determining the relationship between the set of relevant metrics for the application and the response time of the application using a support vector machine.

In some embodiments, a method may be performed by a processing resource executing instructions. The method may include obtaining training data for a software defined data center, wherein the training data comprises a plurality of training metrics associated with an application and respective response time data associated with the application, extracting a set of relevant metrics from the training data, determining a relationship between the relevant metrics and the respective response time data associated with the application, and predicting future performance of the application based on the relationship between the relevant features of the training data and the respective response time data associated with the application.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives. modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium storing instructions executable by a processing resource to:
determine a particular response time and an average response time of an application based on a plurality of relevant performance metrics associated with the application during a first period of time:
classify the particular response time into a group based on the average response time:
determine a relationship between the plurality of relevant performance metrics and the particular response time of the application; and
determine whether a response time of the application is likely to change sufficiently to change the classification to a different group during a second period of time based on the relationship.

2. The non-transitory medium of claim 1, wherein the instructions to determine whether the response time of the application is likely to change sufficiently to change the classification to the different group during the second period of time include instructions to determine whether the response time of the application is likely to change sufficiently to change the classification to the different group during the second period of time based on updated relevant performance metrics.

3. The non-transitory medium of claim 1, wherein the instructions to determine whether the response time of the application is likely to change include instructions to determine whether the response time of the application is likely to increase during the second period of time.

4. The non-transitory medium of claim 1, wherein each respective group represents a discrete time interval associated with a particular range of time associated with the particular response time and the average response time.

5. The non-transitory medium of claim 1, wherein the relevant performance metrics include an application level performance metric and an infrastructure level performance metric.

6. The non-transitory medium of claim 1, wherein the instructions are further executable by the processing resource to generate an alert indicating that the response time of the application is likely to change.

7. The non-transitory medium of claim 6, wherein the instructions are further executable by the processing resource to send the alert to a user.

8. The non-transitory medium of claim 1, wherein the instructions are further executable by the processing resource to display, via a graphical user interface, a likelihood that the particular response time of the application is likely to change.

9. A method of predicting application slowdown, the method comprising:
constructing an input data set from a plurality of application level metrics associated with an application and a plurality of infrastructure level metrics associated with the application;
determining a particular response time and an average response time of the application based on the plurality of application level metrics and the plurality of infrastructure level metrics;
classifying the particular response time into a category based on the average response time;
determining, for the application, a set of relevant metrics comprising application level metrics from the plurality of application level metrics and infrastructure metrics from the plurality of infrastructure metrics that affect the particular response lime of the application;
constructing a prediction model based on the set of relevant metrics for the application;
determining a relationship between the set of relevant metrics and the particular response time of the application; and
determining, based on the relationship between the set of relevant metrics for the application and the particular response time of the application, whether the application is likely to experience application slowdown.

10. The method of claim 9, further comprising generating, in response to determining whether the application is likely to experience application slowdown, an alert indicating that the application is likely to experience application slowdown.

11. The method of claim 9, further comprising determining whether the application is likely to experience application slowdown within a configurable lime interval.

12. The method of claim 9, further comprising, prior to determining whether the application is likely to experience application slowdown, determining the relationship between the set of relevant metrics for the application and the particular response time of the application using a machine learning technique.

13. The method of claim 12, further comprising determining the relationship between the set of relevant metrics for the application and the response time of the application using a support vector machine.

14. A system, comprising:
a first host, a second host, and a third host, each provisioned with a respective processing resource and a respective memory resource, wherein:
the first host is configured to:
generate a plurality of application level performance metrics and a plurality of infrastructure level performance metrics associated with respective applications among a plurality of applications;
the second host is configured to:
receive the plurality of application level performance metrics;
determine relevant performance metrics from the plurality of application level performance metrics; and
generate the plurality of infrastructure level performance metrics associated with the respective applications among the plurality of applications;
the third host is configured to:
receive the plurality of relevant infrastructure performance metrics and the plurality of relevant application level performance metrics:
determine a relationship between the plurality of relevant application level metrics, the plurality of relevant infrastructure level metrics, and a particular response time associated with each respective application among the plurality of applications; and
determine, based on the relationship, whether the response time associated with a particular application among the plurality of applications is likely to change within a configurable time interval.

15. The system of claim 14, wherein the first host includes a plurality of application agents configured to generate the plurality of application level performance metrics.

16. The System of claim 14, wherein the third host is further configured to classify the respective applications into respective categories among a plurality of categories, wherein each category among the plurality of categories is based on the particular response time data associated with the respective application and an average response time associated with the respective application.

17. The system of claim 16, wherein at least one category among the plurality of categories indicates that the respective application is operating at a normal response time, and wherein at least one category among the plurality of categories indicates that the respective application is operating at a non-normal response lime.

18. The system of claim 17, wherein the non-normal response time indicates that the respective application is in a stall stale.

19. The system of claim 14, wherein the respective applications include application program interface (API) calls.

20. The system of claim 14, wherein the third host further comprises a risk prediction dashboard to display a level of risk indicating how likely it is that the response time associated with the particular application among the plurality of applications will change within the configurable time interval.

21. A method performed by a processing resource executing instructions, the method comprising:
obtaining training data for a software defined data center, wherein the training data comprises a plurality of training metrics associated with an application and respective response time data associated with the application:
extracting a set of relevant metrics from the training data;
determining a relationship between the relevant metrics and the respective response time data associated with the application; and
predicting future performance of the application based on the relationship between the relevant features of the training data and the respective response lime data associated with the application.
